(19) United States
(12) Patent Application Publication
(10) Pub. No.: US 2024/0031955 A1
(43) Pub. Date: Jan. 25, 2024

(54) TIME SYNCHRONIZATION APPARATUS, TIME SYNCHRONIZATION SYSTEM, AND TIME SYNCHRONIZATION METHOD

(71) Applicant: NEC Corporation, Tokyo (JP)

(72) Inventor: Daichi Ishikura, Tokyo (JP)

(73) Assignee: NEC Corporation, Tokyo (JP)

(21) Appl. No.: 18/222,796

(22) Filed: Jul. 17, 2023

(30) Foreign Application Priority Data
Jul. 22, 2022 (JP) 2022-117514

(51) Int. Cl. H04W 56/00

(52) U.S. Cl. CPC H04W 56/001; H04W 56/0095; H04J 3/0667

(57) ABSTRACT

Time synchronization is precisely carried out based on pieces of time information in at least two time synchronization schemes. A time synchronization apparatus (1) includes: an acquisition section (11) that acquires pieces of time information of at least two time synchronization schemes among a plurality of time synchronization schemes; an extraction section (12) that extracts reliability of each of the pieces of time information; and a time synchronization section (13) that carries out time synchronization by deciding synchronization time information based on the reliability of each of the pieces of time information.

This Nonprovisional application claims priority under U.S.C. § 119 on Patent Application No. 2022-117514 filed in Japan on Jul. 22, 2022, the entire contents of which are hereby incorporated by reference.

### TECHNICAL FIELD

The present invention relates to a time synchronization apparatus, a time synchronization system, and a time synchronization method.

### BACKGROUND ART

In radio access schemes of long term evolution (LTE) and a fifth-generation mobile communication system (5G), high-precision time synchronization between base stations is necessary in order to carry out interference suppression and handover between base stations. The synchronization precision is demanded to be kept to 1.5 μs or less. Meanwhile, in schemes using network time protocol (NTP) packets and the like which are generally used in time synchronization of a server or the like, it is impossible to satisfy the precision, and a system needs to be constructed for high-precision time synchronization.

Examples of a scheme for carrying out high-precision time synchronization include a time synchronization scheme using a global navigation satellite system (GNSS), a time synchronization scheme using radio signals, a time synchronization scheme that transmits and receives packets on a local area network (LAN), and the like.

As a related technology, there is an invention disclosed in Patent Literature 1 below. Patent Literature 1 indicates that at least one of decision of a predetermined communication scheme from among a plurality of communication schemes, and decision of a predetermined synchronization scheme from among a plurality of synchronization schemes is carried out using one or more condition values acquired.

### CITATION LIST

### Patent Literature

[Patent Literature 1]

Japanese Patent Application Publication Tokukai No. 2016-174215

### SUMMARY OF INVENTION

### Technical Problem

In a time synchronization scheme using a GNSS, GNSS satellites are constantly moving. Therefore, depending on the time zone, a signal from a GNSS satellite cannot be stably received, and time synchronization may not be precisely carried out.

In a time synchronization scheme using radio signals, a radio signal is used. Therefore, many users use wireless communication, and in a time zone in which a communication volume is large, there are cases where a synchronizing signal cannot be precisely received due to interference by radio waves.

A time synchronization scheme that is carried out by packet transmission and reception on a LAN (e.g., a time synchronization scheme using an IEEE-1588 precision time protocol (PTP)) is a technique that carries out time synchronization via Ethernet (registered trademark). However, there are cases in which time synchronization cannot be precisely carried out because of unreached packets due to an increase in network load, an increase in amount of delay, fluctuations, and the like.

Patent Literature 1 indicates that a predetermined synchronization scheme is decided from among a plurality of synchronization schemes using one or more condition values acquired. However, Patent Literature 1 does not disclose a specific synchronization scheme and a method of deciding a specific synchronization scheme.

An example aspect of the present invention is accomplished in view of the above problems, and its example object is to provide a technique that makes it possible to precisely carry out time synchronization based on pieces of time information in at least two time synchronization schemes.

### Solution to Problem

A time synchronization apparatus according to an example aspect of the present invention includes at least one processor, the at least one processor carrying out: an acquisition process of acquiring pieces of time information of at least two time synchronization schemes among a plurality of time synchronization schemes; an extraction process of extracting reliability of each of the pieces of time information; and a time synchronization process of carrying out time synchronization by deciding synchronization time information based on the reliability of each of the pieces of time information.

A time synchronization system according to an example aspect of the present invention includes at least one processor, the at least one processor carrying out: an acquisition process of acquiring pieces of time information of at least two time synchronization schemes among a plurality of time synchronization schemes; an extraction process of extracting reliability of each of the pieces of time information; and a time synchronization process of carrying out time synchronization by deciding synchronization time information based on the reliability of each of the pieces of time information.

A time synchronization method according to an example aspect of the present invention includes: acquiring pieces of time information of at least two time synchronization schemes among a plurality of time synchronization schemes; extracting reliability of each of the pieces of time information; and carrying out time synchronization by deciding synchronization time information based on the reliability of each of the pieces of time information.

A program according to an example aspect of the present invention causes a computer to carry out: an acquisition process of acquiring pieces of time information of at least two time synchronization schemes among a plurality of time synchronization schemes; an extraction process of extracting reliability of each of the pieces of time information; and a time synchronization process of carrying out time synchronization by deciding synchronization time information based on the reliability of each of the pieces of time information.

### Advantageous Effects of Invention

According to an example aspect of the present invention, it is possible to precisely carry out time synchronization based on pieces of time information in at least two time synchronization schemes.

### BRIEF DESCRIPTION OF DRAWINGS

FIG. 1 is a block diagram illustrating a configuration example of a time synchronization apparatus according to a first example embodiment of the present invention.

FIG. 2 is a flowchart illustrating a flow of a processing method that is carried out by the time synchronization apparatus according to the first example embodiment of the present invention.

FIG. 3 is a block diagram illustrating a configuration example of a time synchronization system according to the first example embodiment of the present invention.

FIG. 4 is a block diagram illustrating a configuration example of a time synchronization apparatus according to a second example embodiment of the present invention.

FIG. 5 is a diagram schematically illustrating time synchronization (1) which is carried out by a time synchronization apparatus disposed in a base station.

FIG. 6 is a diagram schematically illustrating time synchronization (2) which is carried out by a time synchronization apparatus disposed in a base station.

FIG. 7 is a diagram illustrating an example of attachment information in a GNSS time synchronization scheme.

FIG. 8 is a diagram illustrating an example of attachment information in a network listening time synchronization scheme.

FIG. 9 is a diagram illustrating an example of a table for extracting reliability of each time synchronization scheme.

FIG. 10 is a block diagram illustrating a configuration of a computer that functions as a time synchronization apparatus or a time synchronization system according to each example embodiment.

### EXAMPLE EMBODIMENTS

### First Example Embodiment

### Overview of Invention

A time synchronization scheme using a GNSS is a technique for carrying out time synchronization by receiving time information transmitted from an artificial satellite (GNSS satellite). However, acquisition of GNSS signals may become unstable due to indoor use, an unsuitable GNSS satellite position (i.e., GNSS satellites are concentrated on the opposite side of the earth), maintenance of GNSS satellites, and the like.

A time synchronization scheme using radio signals is a technique for carrying out time synchronization using radio waves from a precisely synchronized base station. However, there are cases where time synchronization cannot be precisely carried out due to deterioration in radio wave quality caused by upsurge of base stations, unreached radio waves caused by temporary construction work or installation of a shield, and the like.

A time synchronization scheme using a PTP is a technique for carrying out time synchronization via Ethernet (registered trademark) using PTP packets. However, there are cases in which time synchronization cannot be precisely carried out because of unreached packets due to an increase in network load, an increase in amount of delay, fluctuations, and the like.

In a time synchronization apparatus according to the present example embodiment, time synchronization is carried out by deciding synchronization time information for carrying out time synchronization in accordance with reliability of each of pieces of time information of at least two time synchronization schemes among the above described time synchronization schemes. This makes it possible to realize precise time synchronization with an inexpensive configuration.

<Time Synchronization Apparatus 1 According to First Example Embodiment>

The following description will discuss a first example embodiment of the present invention in detail with reference to the drawings. The present example embodiment is a basic form of example embodiments described later. Note that reference signs which are indicated in the drawings and are used in this overview are given to elements for convenience as an example for assisting in understanding, and are not intended to limit the present invention to the illustrated aspects. The connection lines between blocks in the drawings and the like referred to in the descriptions below include both a bidirectional relation and a unidirectional relation. The one-way arrow schematically indicates a flow of a main signal (data), and does not exclude bidirectionality. The connection point of an input and an output of each of the blocks in the drawings may be configured to include a port or an interface. The configurations of these are not illustrated.

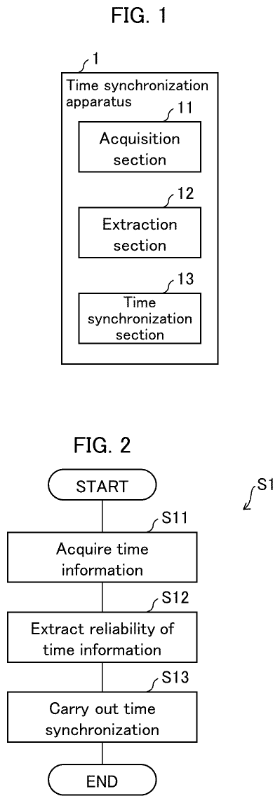

FIG. 1 is a block diagram illustrating a configuration example of a time synchronization apparatus 1 according to the first example embodiment of the present invention. The time synchronization apparatus 1 according to the present example embodiment is an apparatus that is to be applied to a base station or the like, and includes an acquisition section 11, an extraction section 12, and a time synchronization section 13. Hereinafter, a base station to which the time synchronization apparatus 1 is applied may be referred to as its own base station.

The acquisition section 11 acquires pieces of time information of at least two time synchronization schemes among a plurality of time synchronization schemes. Examples of the time synchronization scheme include, but not limited to, a time synchronization scheme using a GNSS, a time synchronization scheme using radio signals (hereinafter, referred to as a network listening time synchronization scheme), a time synchronization scheme using a PTP, and the like.

For example, in a case where the time synchronization scheme is the time synchronization scheme using a GNSS, the acquisition section 11 can acquire time information by receiving a synchronizing signal that is transmitted from a GNSS satellite, and processing the synchronizing signal.

In a case where the time synchronization scheme is the network listening time synchronization scheme, the acquisition section 11 receives a radio signal that is transmitted from another base station, and carries out signal processing on the received radio signal to calculate a difference (time information) in start timing of a radio frame from its own base station. Note that the acquisition section 11 can also calculate an absolute time in accordance with the difference in start timing.

In a case where the time synchronization scheme is the time synchronization scheme using a PTP, the acquisition section 11 can acquire time information by receiving time information delivered from a PTP grand master.

The extraction section 12 extracts reliability of time information. For example, in a case where the time synchronization scheme is the time synchronization scheme using a GNSS, the extraction section 12 receives GNSS signals from a plurality of GNSS satellites, and extracts reliability of time information in accordance with the number of satellites for which a reception SN value (reception sensitivity), which is reception strength of the GNSS signal, is not less than a predetermined value.

In a case where the time synchronization scheme is the network listening time synchronization scheme, the extraction section 12 receives a radio signal transmitted from another base station, and extracts reliability of time information in accordance with reception strength of the radio signal.

The time synchronization section 13 carries out time synchronization by deciding synchronization time information based on reliability of time information. The synchronization time information is time information that is used to carry out time synchronization. For example, the time synchronization section 13 selects, as the synchronization time information, time information having highest reliability among pieces of time information of at least two time synchronization schemes. Then, the time synchronization section 13 carries out time synchronization using the synchronization time information.

For example, in a case where the time synchronization section 13 has selected time information of a network listening time synchronization scheme, the time synchronization section 13 can carry out time synchronization by correcting a start timing of a radio frame of its own base station by an error (which is time information) in start timing of a radio frame from its own base station.

Alternatively, in a case where the time synchronization section 13 has selected time information of the GNSS time synchronization scheme, the time information is acquired as an absolute time. Therefore, the time synchronization section 13 can carry out time synchronization by converting the time information into an error in start timing of a radio frame for adjusting the unit, and correcting a start timing of a radio frame.

<Advantage of Time Synchronization Apparatus 1>

As described above, according to the time synchronization apparatus 1 of the present example embodiment, the time synchronization section 13 carries out time synchronization by deciding synchronization time information based on reliability of time information.

Therefore, it is possible to realize precise time synchronization with an inexpensive configuration.

<Flow of Processing Method by Time Synchronization Apparatus 1>

The following description will discuss a flow of a processing method that is carried out by the time synchronization apparatus 1 configured as described above, with reference to FIG. 2. FIG. 2 is a flowchart illustrating the flow of the processing method that is carried out by the time synchronization apparatus 1 according to the first example embodiment. As illustrated in FIG. 2, a processing method Si includes steps S11 through S13.

First, the acquisition section 11 acquires pieces of time information of at least two time synchronization schemes among a plurality of time synchronization schemes (S11). Examples of the time synchronization scheme include, but not limited to, a time synchronization scheme using a GNSS, a network listening time synchronization scheme, a time synchronization scheme using a PTP, and the like.

For example, in a case where the time synchronization scheme is the network listening time synchronization scheme, the acquisition section 11 receives a radio signal that is transmitted from another base station, and carries out signal processing on the received radio signal to calculate a difference (time information) in start timing of a radio frame from its own base station.

Next, the extraction section 12 extracts reliability of time information (S12). For example, in a case where the time synchronization scheme is the network listening time synchronization scheme, the extraction section 12 receives a radio signal transmitted from another base station, and extracts reliability of time information in accordance with reception strength of the radio signal.

Next, the time synchronization section 13 carries out time synchronization by deciding synchronization time information based on reliability of time information (S13). The synchronization time information is time information that is used to carry out time synchronization. For example, the time synchronization section 13 selects, as the synchronization time information, time information having highest reliability among pieces of time information of at least two time synchronization schemes. Then, the time synchronization section 13 carries out time synchronization using the synchronization time information.

<Advantage of Processing Method by Time Synchronization Apparatus 1>

As described above, according to the processing method carried out by the time synchronization apparatus 1 of the present example embodiment, the time synchronization section 13 carries out time synchronization by deciding synchronization time information based on reliability of time information. Therefore, it is possible to realize precise time synchronization with an inexpensive configuration.

<Time Synchronization System 100 According to First Example Embodiment>

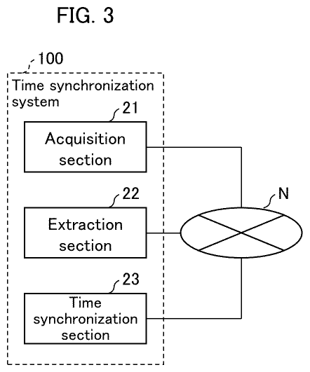

FIG. 3 is a block diagram illustrating a configuration example of a time synchronization system 100 according to the first example embodiment of the present invention. As illustrated in FIG. 3, the time synchronization system 100 according to the present example embodiment includes an acquisition section 21, an extraction section 22, and a time synchronization section 23.

The acquisition section 21, the extraction section 22, and the time synchronization section 23 are, for example, configured to be communicable to each other via a network N. Here, a specific configuration of the network N does not limited the present example embodiment but, as an example, it is possible to employ a wireless local area network (LAN), a wired LAN, a wide area network (WAN), a public network, a mobile data communication network, or a combination of these networks.

Note that the functions of the time synchronization system 100 can be mounted on a cloud. For example, the acquisition section 21 and the extraction section 22 can constitute a single apparatus, and the time synchronization section 23 can constitute a single apparatus. These can be mounted on a single apparatus, or can be mounted on separate apparatuses. For example, in a case of being mounted on separate apparatuses, pieces of information of the respective sections are transmitted and received via the network N to proceed with a process.

The acquisition section 21 acquires pieces of time information of at least two time synchronization schemes among a plurality of time synchronization schemes.

Examples of the time synchronization scheme include, but not limited to, a time synchronization scheme using a GNSS, a network listening time synchronization scheme, a time synchronization scheme using a PTP, and the like.

For example, in a case where the time synchronization scheme is the network listening time synchronization scheme, the acquisition section 21 receives a radio signal that is transmitted from another base station, and carries out signal processing on the received radio signal to calculate a difference (time information) in start timing of a radio frame from its own base station.

The extraction section 22 extracts reliability of time information. For example, in a case where the time synchronization scheme is the network listening time synchronization scheme, the extraction section 22 receives a radio signal transmitted from another base station, and extracts reliability of time information in accordance with reception strength of the radio signal.

The time synchronization section 23 carries out time synchronization by deciding synchronization time information based on reliability of time information. The synchronization time information is time information that is used to carry out time synchronization. For example, the time synchronization section 23 selects, as the synchronization time information, time information having highest reliability among pieces of time information of at least two time synchronization schemes. Then, the time synchronization section 23 carries out time synchronization using the synchronization time information.

<Advantage of Processing Method by Time Synchronization System 100>

As described above, according to the time synchronization system 100 of the present example embodiment, the time synchronization section 23 carries out time synchronization by deciding synchronization time information based on reliability of time information.

Therefore, it is possible to realize precise time synchronization with an inexpensive configuration.

### Second Example Embodiment

<Configuration Example of Time Synchronization Apparatus 1A According to Second Example Embodiment>

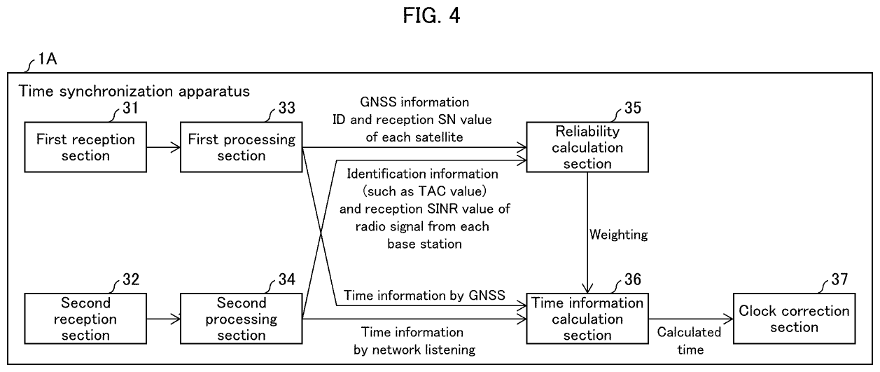

FIG. 4 is a diagram illustrating a configuration of a time synchronization apparatus 1A according to a second example embodiment of the present invention. The time synchronization apparatus 1A according to the present example embodiment includes a first reception section 31, a second reception section 32, a first processing section 33, a second processing section 34, a reliability calculation section 35, a time information calculation section 36, and a clock correction section 37.

The first reception section 31, the second reception section 32, the first processing section 33, and the second processing section 34 are configured to realize the acquisition section in the present example embodiment. The reliability calculation section 35 is configured to realize the extraction section in the present example embodiment. The time information calculation section 36 and the clock correction section 37 are configured to realize the time synchronization section in the present example embodiment.

In the present example embodiment, a case will be described in which the time synchronization apparatus 1A can use two time synchronization techniques, i.e., time synchronization by a GNSS and time synchronization by network listening. Note, however, that the present example embodiment is not limited to this.

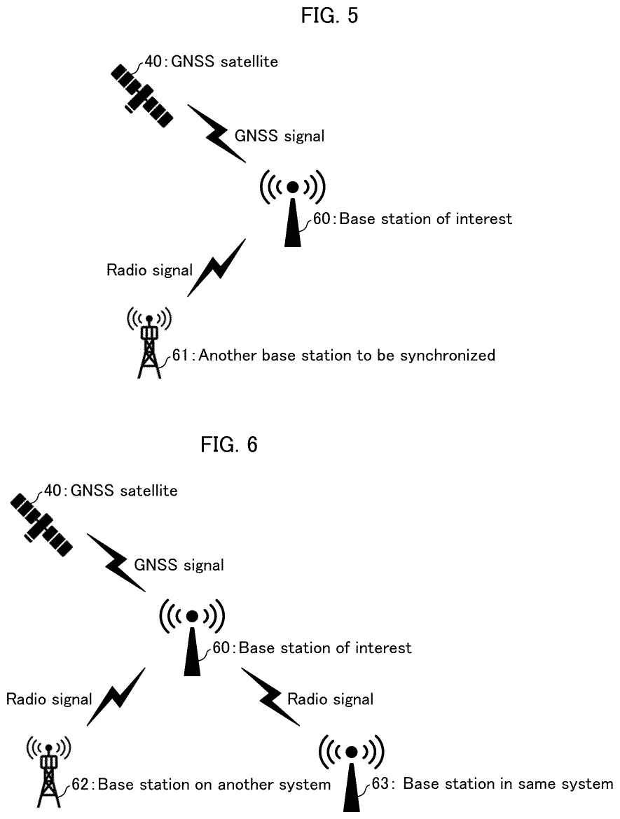

FIG. 5 and FIG. 6 are diagrams each schematically illustrating time synchronization by the time synchronization apparatus 1A disposed in a base station. As illustrated in FIG. 5, a base station 60 in which the time synchronization apparatus 1A is disposed can receive a GNSS signal from a GNSS satellite 40. Moreover, the base station 60 in which the time synchronization apparatus 1A is disposed can receive a radio signal from another base station 61 that is to be synchronized with the base station 60.

As illustrated in FIG. 6, a base station 60 in which the time synchronization apparatus 1A is disposed can receive a GNSS signal from a GNSS satellite 40. The base station 60 in which the time synchronization apparatus 1A is disposed may receive radio signals from a base station 62 on another system and a base station 63 in the same system as the base station 60.

The first reception section 31 receives a GNSS signal from a GNSS satellite. Specifically, the first reception section 31 is constituted by an antenna for a GNSS, a coaxial cable for distributing a GNSS signal to its own base station, an amplifier, and the like. In a case where its own base station is installed outdoors, an antenna for a GNSS can be built in its own base station or attached to a body of its own base station. Further, a cable, an amplifier, and the like may be disposed outside its own base station, and only a connector portion of the cable may be connected to its own base station.

The first processing section 33 carries out signal processing on a GNSS signal received by the first reception section 31, acquires latitude-longitude information of its own base station and time information, and outputs the pieces of information to the time information calculation section 36. The first processing section 33 acquires, as attachment information, a GNSS satellite number and SN information (reception SN) of each GNSS satellite, and outputs the acquired information to the reliability calculation section 35.

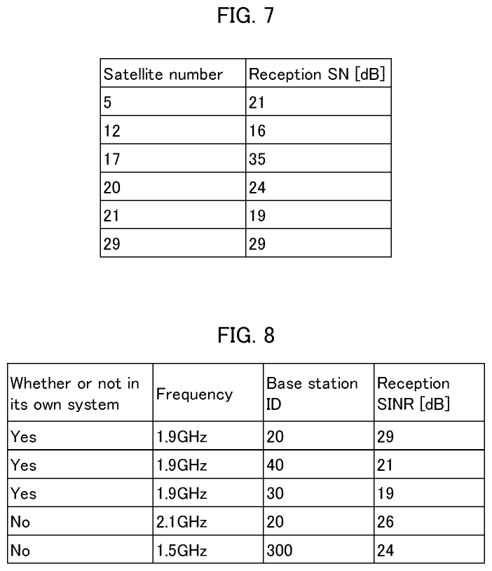

FIG. 7 is a diagram illustrating an example of attachment information in a GNSS time synchronization scheme. As illustrated in FIG. 7, in a case where the first reception section 31 can receive GNSS signals from a plurality of GNSS satellites, GNSS satellite numbers of the respective GNSS satellites and pieces of SN information (reception SN) of the respective GNSS satellites are stored in association with each other.

The second reception section 32 receives a radio signal (network listening signal) from another base station. Typically, the second reception section 32 also carries out reception of radio waves from another base station using an antenna for radio wave transmission of its own base station. However, it is possible to use an antenna dedicated to reception of radio waves from another base station.

The second processing section 34 carries out signal processing on a radio signal received by the second reception section 32. Then, the second processing section 34 acquires a start timing of a radio frame of a synchronization target base station to be synchronized with its own base station, calculates an error from the timing of its own base station, and outputs the error to the time information calculation section 36. The second processing section 34 acquires, as the attachment information, various pieces of information (e.g., whether the synchronization target base station is included in the same system (hereinafter, “its own system”) as its own base station, frequency, ID information of the synchronization target base station, and information on strength of a radio signal (such as a signal-to-interference plus noise power ratio (SINR))) of the synchronization target base station, and outputs the pieces of information to the reliability calculation section 35.

FIG. 8 is a diagram illustrating an example of attachment information in a network listening time synchronization scheme. As illustrated in FIG. 8, in a case where the second reception section 32 can receive radio signals from a plurality of base stations, information on whether or not each of the base stations is included in its own system, a frequency of each of the base stations, a base station ID of each of the base stations, and a received SINR of each of the base stations, are stored in association with each other. Note that the information on strength of a radio signal can be another index such as a reference signal received power (RSRP), a reference signal received quality (RSRQ), or the like.

The reliability calculation section 35 calculates reliability of time information of the GNSS time synchronization scheme using attachment information which pertains to the GNSS time synchronization scheme and which is output from the first processing section 33. Specifically, the reliability calculation section 35 extracts reliability of time information in accordance with the number of satellites for which reception strength is not less than a predetermined value.

The reliability calculation section 35 calculates reliability of time information of the GNSS time synchronization scheme by, for example, the following Formula 1.

Reliability=(Number of GNSS satellites for which reception SN value is not less than 25 dB)×16 Formula 1:

The reliability calculation section 35 calculates reliability of time information of the network listening time synchronization scheme using attachment information which pertains to the network listening time synchronization scheme and which is output from the second processing section 34. Specifically, the reliability calculation section 35 extracts reliability of time information in accordance with reception strength of a radio signal from a base station. The reliability calculation section 35 calculates reliability of time information of the network listening time synchronization scheme by, for example, the following Formula 2.

Reliability=(Highest SINR value [dB] among received radio signals)×3 Formula 2:

For example, in a case where the time synchronization apparatus 1A uses the PTP time synchronization scheme, the reliability calculation section 35 may extract reliability of time information in accordance with a traffic volume and an amount of delay in a network. For example, reliability of time information of the PTP time synchronization scheme is calculated by the following Formula 3.

Reliability=(1−Traffic volume [Mbps]/1000)×100−(Amount of delay of PTP packet [ns])×0.1 Formula 3:

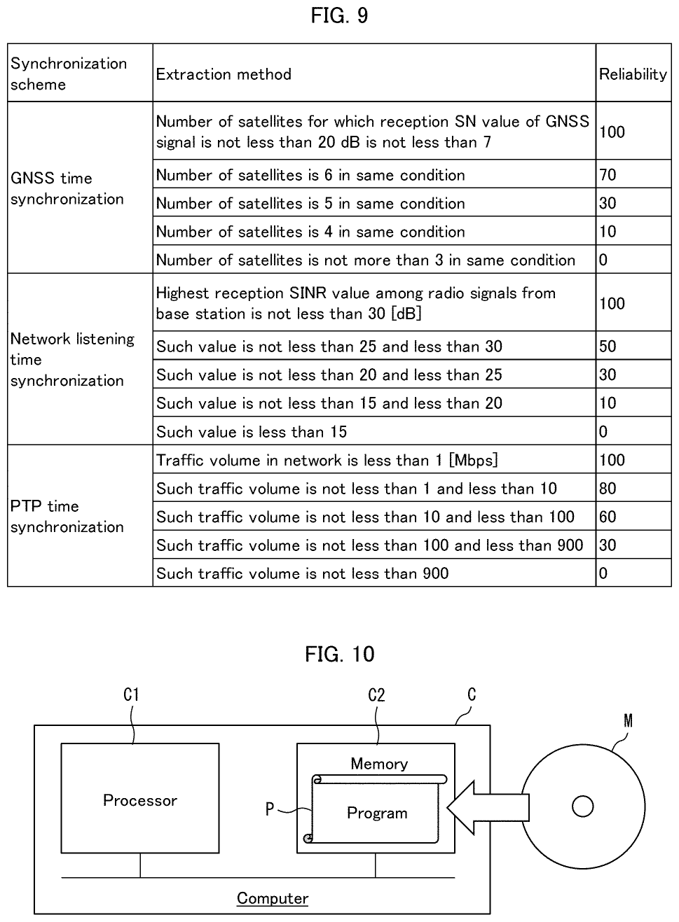

FIG. 9 is a diagram illustrating a table for extracting reliability of each time synchronization scheme. FIG. 9 illustrates, as an example, a table for extracting reliability in the GNSS time synchronization scheme, the network listening time synchronization scheme, and the PTP time synchronization scheme. The reliability calculation section may carry out calculation based on the foregoing Formulae 1 through 3, or may extract reliability of time information in each time synchronization scheme with reference to the table illustrated in FIG. 9.

For the GNSS time synchronization scheme, reliability corresponding to the number of satellites for which a reception SN value of a GNSS signal is not less than 20 dB is indicated. For example, in a case where the number of satellites for which the reception SN value of the GNSS signal is not less than 20 dB is not less than 7, reliability of 100 can be extracted with reference to the table illustrated in FIG. 9.

For the network listening time synchronization scheme, reliability is indicated in accordance with a highest reception SINR value among radio signals from a base station. For example, in a case where the highest reception SINR value among the radio signals from the base station is not less than 25 dB and less than 30 dB, reliability of 50 can be extracted with reference to the table illustrated in FIG. 9.

For the PTP time synchronization scheme, reliability is indicated in accordance with a traffic volume in the network. For example, in a case where the traffic volume in the network is not less than 1 Mbps and less than 10 Mbps, reliability of 80 can be extracted with reference to the table illustrated in FIG. 9.

The time information calculation section 36 decides synchronization time information based on reliability of time information of the GNSS time synchronization scheme and reliability of time information of the network listening time synchronization scheme. For example, the time information calculation section 36 selects, based on the reliability of the time information, time information of one of at least two time synchronization schemes. More specifically, the time information calculation section 36 selects time information of a time synchronization scheme for which reliability of time information is higher.

The time information calculation section 36 carries out calculation while weighting pieces of time information of at least two time synchronization schemes based on reliability of each of the pieces of time information. For example, as shown in Formula 4 below, synchronization time information T is calculated by calculating, while using reliability of time information as a weight, a weighted average using the reliability. Note that ω1 is reliability (weight) of time information of a GNSS time synchronization scheme, and T1 is time information of the GNSS time synchronization scheme. ω2 is reliability (weight) of time information of a network listening time synchronization scheme, and T2 is time information of the network listening time synchronization scheme.

T=(ω1×T1+ω2×T2)/(ω1+ω2) Formula 4:

In the case of the network listening time synchronization scheme, time information is obtained as an error in start timing of a radio frame. In the case of the GNSS time synchronization scheme, time information is obtained as an absolute time. Therefore, a weighted average of values obtained according to Formula 3 above is calculated after one of the pieces of time information is converted into the same format as the other piece of time information.

The calculation formula is not limited to Formula 3, and any of other calculation formulae can be used. For example, in a case where reliabilities of the time synchronization schemes are all not less than 30, synchronization time information may be calculated using the above described weighted average. Alternatively, in a case where reliability of any of the time synchronization schemes is not more than 30, time information of the other time synchronization scheme may be used as synchronization time information.

The clock correction section 37 carries out time synchronization using the synchronization time information calculated by the time information calculation section 36. For example, in a case of the network listening time synchronization scheme, time information is obtained as an error in start timing of a radio frame. Therefore, the clock correction section 37 carries out time synchronization by determining an error between the obtained start timing of the radio frame and a start timing of its own base station, and correcting the start timing of the radio frame of its own base station by the error.

Time information by the GNSS time synchronization scheme is obtained as an absolute time. Therefore, the absolute time may be converted into a start timing of a radio frame for adjusting the unit.

In the above descriptions, the case has been described in which the time synchronization apparatus 1A carries out time synchronization using the GNSS time synchronization scheme and the network listening time synchronization scheme. Note, however, that neighboring base stations do not need to use the two synchronization schemes, and may use another synchronization scheme. For example, in the configuration as illustrated in FIG. 6, it is possible that the time synchronization apparatus 1A is disposed in the base station 60, the base station 62 employs only a GNSS time synchronization scheme, and the base station 63 employs a PTP time synchronization scheme.

This synchronization timing may be the same timing as the time synchronization, or may be another timing. For example, in a case where various signals are acquired every second to carry out time correction, reliability may be calculated every second or, alternatively, reliability may be calculated, for example, only once in 60 seconds and the same reliability may be used for time corrections of 60 times, which are carried out during the subsequent 60 seconds.

<Advantage of Time Synchronization Apparatus 1A>

As described above, according to the time synchronization apparatus 1A of the present example embodiment, it is possible to carry out time synchronization of base stations even in a situation in which time synchronization is not stable. Generally, in a case where a plurality of base stations use the same wireless communication standard and frequency to guarantee the handover function, and time synchronization between the base stations is not carried out, there is a concern that interference of uplink data communication increases, leading to a decrease in throughput. There is also a concern that handover fails and communication is interrupted.

Therefore, it is necessary to precisely adjust time information between base stations. However, in a case where base stations are disposed indoors or in a dense area, it is difficult to continuously and stably carry out time synchronization even by using GNSS signals or using a network listening function. In the present example embodiment, for a base station that employs two or more time synchronization schemes (that is, time synchronization by a GNSS and time synchronization by a network listening function), which are synchronization schemes not stable in the long term, more emphasis is placed on time information by a more stable one of the time synchronization schemes in accordance with situations. Therefore, it is possible to carry out high-precision time synchronization.

[Software Implementation Example]

The functions of part of or all of the time synchronization apparatuses 1 and 1A and the time synchronization system 100 can be realized by hardware such as an integrated circuit (IC chip) or can be alternatively realized by software.

In the latter case, each of the time synchronization apparatuses 1 and 1A and the time synchronization system 100 is realized by, for example, a computer that executes instructions of a program that is software realizing the foregoing functions. FIG. 10 illustrates an example of such a computer (hereinafter, referred to as “computer C”). The computer C includes at least one processor C1 and at least one memory C2. The memory C2 stores a program P for causing the computer C to function as the time synchronization apparatuses 1 and 1A and the time synchronization system 100. In the computer C, the processor C1 reads the program P from the memory C2 and executes the program P, so that the functions of the time synchronization apparatuses 1 and 1A and the time synchronization system 100 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a RAM in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

Some of or all of the foregoing example embodiments can also be described as below. Note, however, that the present invention is not limited to the following supplementary notes.

(Supplementary Note 1)

A time synchronization apparatus, including: an acquisition means that acquires pieces of time information of at least two time synchronization schemes among a plurality of time synchronization schemes; an extraction means that extracts reliability of each of the pieces of time information; and a time synchronization means that carries out time synchronization by deciding synchronization time information based on the reliability of each of the pieces of time information.

According to the configuration, it is possible to precisely carry out time synchronization based on pieces of time information in at least two time synchronization schemes.

(Supplementary Note 2)

The time synchronization apparatus according to supplementary note 1, in which: the time synchronization means selects, based on the reliability of each of the pieces of time information, time information of one of the at least two time synchronization schemes, and carries out time synchronization while using, as the synchronization time information, the time information which has been selected.

According to the configuration, it is possible to carry out time synchronization based on more precise time information among pieces of time information in at least two time synchronization schemes.

(Supplementary Note 3)

The time synchronization apparatus according to supplementary note 1, in which: the time synchronization means carries out calculation while weighting the pieces of time information of the at least two time synchronization schemes based on the reliability of each of the pieces of time information, and carries out time synchronization while using, as the synchronization time information, a result of the calculation.

According to the configuration, it is possible to calculate synchronization time information while placing more emphasis on time information having higher reliability.

(Supplementary Note 4)

The time synchronization apparatus according to any one of supplementary notes 1 through 3, in which: one of the at least two time synchronization schemes is time synchronization by network listening; and the extraction means extracts the reliability of each of the pieces of time information in accordance with reception strength of a radio signal from a base station.

According to the configuration, it is possible to easily extract reliability of time information of a network listening time synchronization scheme.

(Supplementary Note 5)

The time synchronization apparatus according to supplementary note 4, in which: one of the at least two time synchronization schemes is time synchronization by a GNSS; and the extraction means extracts the reliability of each of the pieces of time information in accordance with the number of satellites for which reception strength is not less than a predetermined value.

According to the configuration, it is possible to easily extract reliability of time information of a GNSS time synchronization scheme.

(Supplementary Note 6)

The time synchronization apparatus according to supplementary note 5, in which: one of the at least two time synchronization schemes is time synchronization by a PTP; and the extraction means extracts the reliability of each of the pieces of time information in accordance with a traffic volume and an amount of delay in a network.

According to the configuration, it is possible to easily extract reliability of time information of a PTP time synchronization scheme.

(Supplementary Note 7)

A time synchronization system, including: an acquisition means that acquires pieces of time information of at least two time synchronization schemes among a plurality of time synchronization schemes; an extraction means that extracts reliability of each of the pieces of time information; and a time synchronization means that carries out time synchronization by deciding synchronization time information based on the reliability of each of the pieces of time information.

According to the configuration, it is possible to precisely carry out time synchronization based on pieces of time information in at least two time synchronization schemes.

(Supplementary Note 8)

A time synchronization method, including: acquiring pieces of time information of at least two time synchronization schemes among a plurality of time synchronization schemes; extracting reliability of each of the pieces of time information; and carrying out time synchronization by deciding synchronization time information based on the reliability of each of the pieces of time information.

According to the configuration, it is possible to precisely carry out time synchronization based on pieces of time information in at least two time synchronization schemes.

(Supplementary Note 9)

A program for causing a computer to carry out: an acquisition process of acquiring pieces of time information of at least two time synchronization schemes among a plurality of time synchronization schemes; an extraction process of extracting reliability of each of the pieces of time information; and a time synchronization process of carrying out time synchronization by deciding synchronization time information based on the reliability of each of the pieces of time information.

According to the configuration, it is possible to precisely carry out time synchronization based on pieces of time information in at least two time synchronization schemes.

(Supplementary Note 10)

A time synchronization apparatus, including at least one processor, the at least one processor carrying out: an acquisition process of acquiring pieces of time information of at least two time synchronization schemes among a plurality of time synchronization schemes; an extraction process of extracting reliability of each of the pieces of time information; and a time synchronization process of carrying out time synchronization by deciding synchronization time information based on the reliability of each of the pieces of time information.

Note that the time synchronization apparatus can further include a memory. The memory can store a program for causing the at least one processor to carry out the acquisition process, the extraction process, and the time synchronization process. The program can be stored in a computer-readable non-transitory tangible storage medium.

(Supplementary Note 11)

A time synchronization system, including at least one processor, the at least one processor carrying out: an acquisition process of acquiring pieces of time information of at least two time synchronization schemes among a plurality of time synchronization schemes; an extraction process of extracting reliability of each of the pieces of time information; and a time synchronization process of carrying out time synchronization by deciding synchronization time information based on the reliability of each of the pieces of time information.

Note that the time synchronization system can further include a memory. The memory can store a program for causing the at least one processor to carry out the acquisition process, the extraction process, and the time synchronization process. The program can be stored in a computer-readable non-transitory tangible storage medium.

### REFERENCE SIGNS LIST

1, 1A: Time synchronization apparatus
11, 21: Acquisition section
12, 22: Extraction section
13, 23: Time synchronization section
31: First reception section
32: Second reception section
33: First processing section
34: Second processing section
35: Reliability calculation section
36: Time information calculation section
37: Clock correction section
100: Time synchronization system

1. A time synchronization apparatus, comprising at least one processor, the at least one processor carrying out:
an acquisition process of acquiring pieces of time information of at least two time synchronization schemes among a plurality of time synchronization schemes;
an extraction process of extracting reliability of each of the pieces of time information; and
a time synchronization process of carrying out time synchronization by deciding synchronization time information based on the reliability of each of the pieces of time information.

2. The time synchronization apparatus according to claim 1, wherein:
in the time synchronization process, the at least one processor
selects, based on the reliability of each of the pieces of time information, time information of one of the at least two time synchronization schemes, and
carries out time synchronization while using, as the synchronization time information, the time information which has been selected.

3. The time synchronization apparatus according to claim 1, wherein:
in the time synchronization process, the at least one processor
carries out calculation while weighting the pieces of time information of the at least two time synchronization schemes based on the reliability of each of the pieces of time information, and
carries out time synchronization while using, as the synchronization time information, a result of the calculation.

4. The time synchronization apparatus according to claim 1, wherein:
one of the at least two time synchronization schemes is time synchronization by network listening; and
in the extraction process, the at least one processor extracts the reliability of each of the pieces of time information in accordance with reception strength of a radio signal from a base station.

5. The time synchronization apparatus according to claim 4, wherein:
one of the at least two time synchronization schemes is time synchronization by a GNSS; and
in the extraction process, the at least one processor extracts the reliability of each of the pieces of time information in accordance with the number of satellites for which reception strength is not less than a predetermined value.

6. The time synchronization apparatus according to claim 5, wherein:
one of the at least two time synchronization schemes is time synchronization by a PTP; and
in the extraction process, the at least one processor extracts the reliability of each of the pieces of time information in accordance with a traffic volume and an amount of delay in a network.

7. A time synchronization system, comprising at least one processor, the at least one processor carrying out:
an acquisition process of acquiring pieces of time information of at least two time synchronization schemes among a plurality of time synchronization schemes;
an extraction process of extracting reliability of each of the pieces of time information; and
a time synchronization process of carrying out time synchronization by deciding synchronization time information based on the reliability of each of the pieces of time information.

8. The time synchronization system according to claim 7, wherein:
in the time synchronization process, the at least one processor
selects, based on the reliability of each of the pieces of time information, time information of one of the at least two time synchronization schemes, and
carries out time synchronization while using, as the synchronization time information, the time information which has been selected.

9. The time synchronization system according to claim 7, wherein:
in the time synchronization process, the at least one processor
carries out calculation while weighting the pieces of time information of the at least two time synchronization schemes based on the reliability of each of the pieces of time information, and
carries out time synchronization while using, as the synchronization time information, a result of the calculation.

10. The time synchronization system according to claim 7, wherein:
one of the at least two time synchronization schemes is time synchronization by network listening; and
in the extraction process, the at least one processor extracts the reliability of each of the pieces of time information in accordance with reception strength of a radio signal from a base station.

11. The time synchronization system according to claim wherein:
one of the at least two time synchronization schemes is time synchronization by a GNSS; and
in the extraction process, the at least one processor extracts the reliability of each of the pieces of time information in accordance with the number of satellites for which reception strength is not less than a predetermined value.

12. The time synchronization system according to claim 11, wherein:
one of the at least two time synchronization schemes is time synchronization by a PTP; and
in the extraction process, the at least one processor extracts the reliability of each of the pieces of time information in accordance with a traffic volume and an amount of delay in a network.

13. A time synchronization method, comprising:
acquiring pieces of time information of at least two time synchronization schemes among a plurality of time synchronization schemes;
extracting reliability of each of the pieces of time information; and
carrying out time synchronization by deciding synchronization time information based on the reliability of each of the pieces of time information.

14. The time synchronization method according to claim 13, wherein:
in the carrying out of time synchronization,
time information of one of the at least two time synchronization schemes is selected based on the reliability of each of the pieces of time information, and
time synchronization is carried out while using, as the synchronization time information, the time information which has been selected.

15. The time synchronization method according to claim 13, wherein:
in the carrying out of time synchronization,
calculation is carried out while weighting the pieces of time information of the at least two time synchronization schemes based on the reliability of each of the pieces of time information, and
time synchronization is carried out while using, as the synchronization time information, a result of the calculation.

16. The time synchronization method according to claim 13, wherein:
one of the at least two time synchronization schemes is time synchronization by network listening; and
in the extracting, the reliability of each of the pieces of time information is extracted in accordance with reception strength of a radio signal from a base station.

17. The time synchronization method according to claim 16, wherein:
one of the at least two time synchronization schemes is time synchronization by a GNSS; and
in the extracting, the reliability of each of the pieces of time information is extracted in accordance with the number of satellites for which reception strength is not less than a predetermined value.

18. The time synchronization method according to claim 17, wherein:
one of the at least two time synchronization schemes is time synchronization by a PTP; and
in the extracting, the reliability of each of the pieces of time information is extracted in accordance with a traffic volume and an amount of delay in a network.
